(19) United States
(12) Patent Application Publication
(10) Pub. No.: US 2007/0259648 A1
(43) Pub. Date: Nov. 8, 2007

(54) Mobile terminal combinable with various types of function module and method for controlling the function module

(76) Inventor: Sang-Bin Moon, Seongnam-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/824,834

(22) Filed: Jul. 2, 2007

Related U.S. Application Data
(63) Continuation of application No. PCT/KR06/03669, filed on Sep. 14, 2006.

(30) Foreign Application Priority Data
Nov. 4, 2005 (KR) 10-2005-0105670
Jan. 3, 2006 (KR) 10-2006-0000387

(51) Int. Cl. H04M 1/66

(52) U.S. Cl. 455/411

(57) ABSTRACT

A mobile terminal combinable with various types of function module, the function module, and a method for controlling the function module are disclosed. In one embodiment, a mobile terminal combinable with various types of function module is provided, wherein the mobile terminal includes a module connector, and a main body for determining the type of a function module combined with the module connector and controlling the function module. At least one embodiment of the present invention can provide a mobile terminal which allows a function module to be selectively combined and detached with a function module for each function such as camera and MP3 player functions, etc.

### RELATED APPLICATIONS

This application is a continuation application, and claims the benefit under 35 U.S.C. §§120 and 365 of PCT Application No. PCT/KR2006/003669, filed on Sep. 14, 2006 and, which is hereby incorporated by reference.

### BACKGROUND OF THE INVENTION

1. Field of the Invention

The present invention relates to a mobile terminal. More particularly, the present invention relates to a mobile terminal which is combinable with various types of function module, the function module, and a method for controlling the function module.

2. Description of the Related Technology

Recently, the mobile terminal has included modules for a variety of functions such as a camera module, MP3 module, and game module, etc., in addition to the basic communication function, due to the various needs of users. This creates a problem that it is uncomfortable for a user to carry the mobile terminal as the size of the mobile terminal increases due to the various function modules.

Also, there is a problem of wasted expense for the user, because the mobile terminal often has modules which are not used much by the user.

### SUMMARY OF CERTAIN INVENTIVE ASPECTS

One aspect of the present invention provides a mobile terminal which allows a function module to be selectively combined and detached with a function module for each function such as camera and MP3 player functions, etc., and a method for controlling the function module.

Another aspect of the present invention provides a mobile terminal and a method for determining the type of combined function module, and executing a control program in correspondence with the determination result.

Another aspect of the present invention provides a mobile terminal combinable with various types of function module with which a control program corresponding to a new function module may be downloaded from a particular server for automatic configuration.

Another aspect of the invention provides a mobile terminal combinable with various types of function module comprising: one or more module connector, and a main body for determining the type of one or more function module combined with the module connector and controlling the combined function module.

In one embodiment, the function module may be at least one of a display module, a camera module, a laser pointer module, a remote control module, a memory module, an MP3 module, and a Bluetooth module. In another embodiment, the module connector may comprise a module recognition part, wherein the main body recognizes the type of the function module using module-recognition information inputted through the module recognition part. In another embodiment, the module connector may further comprise an address part, a data part, a control part, and a power-ground part.

Another aspect of the invention provides a function module comprising: a main body, and a connector combining with a module connector of a mobile terminal, having a module information transmitter for providing to the mobile terminal module-recognition information corresponding to the main body.

Another aspect of the invention provides a mobile terminal combinable with various types of function module comprising: one or more module connector, a main body for determining the type of one or more function module combined with the module connector and controlling the combined function module, and a memory for storing control programs corresponding to each function module, wherein the main body receives a corresponding control program from a predetermined server through a network or from the combined function module through the module connector, if the control program for the function module combined through the module connector is not stored in the memory.

In one embodiment, connection information for connecting with the server may be pre-stored in the memory or may be received form the combined function module. In one embodiment, the main body may determine whether or not the version of the control program corresponding to the function module is the latest version when the control program for the function module is pre-stored in the memory or received from the function module, and may upgrade the control program to the latest version via the server in correspondence with the result. In another embodiment, the main body may transmit function module-recognition information by which the server can recognize the function module. In one embodiment, the module connector may comprise a module recognition part, wherein the main body recognizes the type of the function module using module-recognition information inputted through the module recognition part.

Still another aspect of the invention provides a method and a mobile terminal-readable recording medium storing a program to cause the mobile terminal to execute the method for controlling a function module combined with a mobile terminal, the method comprising: receiving a module-recognition information from the function module combined through a module connector, determining whether or not a control program corresponding the module-recognition information is predetermined, and configuring the control program after receiving the control program from a predetermined server through a network or from the function module combined through the module connector, and executing the control program if the control program is not configured.

In one embodiment, connection information for connecting with the server may be pre-stored or may be received from the function module. In another embodiment, the method may further comprise: determining whether or not the version of the control program corresponding to the function module is the latest version, upgrading the control program to the latest version via the server in correspondence with the result, and executing the control program of the latest version, if the control program for the function module is pre-stored or is received from the function module.

### BRIEF DESCRIPTION OF DRAWINGS

FIG. 1 shows a mobile terminal according to one embodiment of the present invention.

FIGS. 2 to 6 respectively show each function module according to embodiments of the present invention.

FIG. 7 shows a normal mobile terminal and the mobile terminal combined with a function module according to one embodiment of the present invention.

FIG. 8 shows the composition of a module connector according to one embodiment of the present invention.

FIG. 9 shows a pin map of a module connector according to one embodiment of the present invention.

FIG. 10 shows a function module recognition table for function module type recognition and an example of such recognition according to one embodiment of the present invention.

FIG. 11 is a flowchart illustrating the operation of the mobile terminal for controlling a combined function module according to one embodiment of the present invention.

FIG. 12 is a flowchart illustrating the operation of the mobile terminal for configuring the control program of a newly combined function module.

### DETAILED DESCRIPTION OF CERTAIN INVENTIVE EMBODIMENTS

Embodiments of the present invention will be described with respect to accompanying drawings, wherein like reference numerals refer to the like elements throughout.

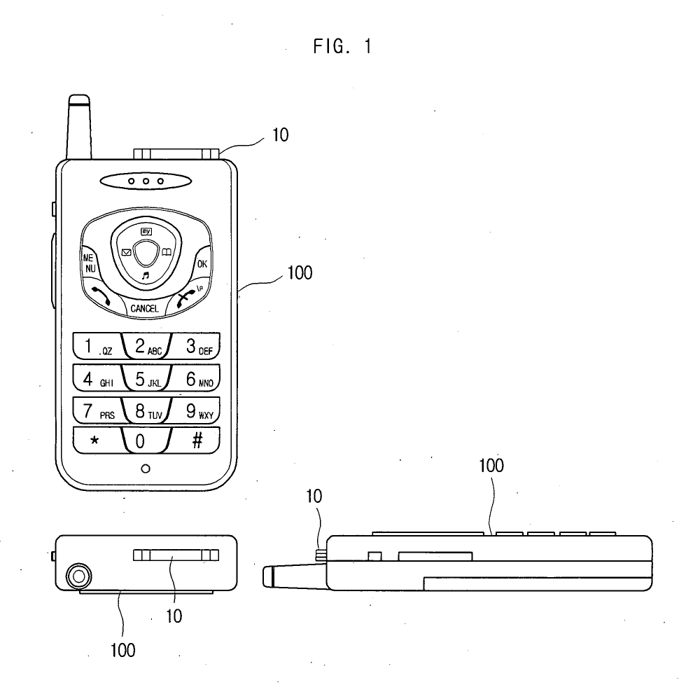

FIG. 1 shows a mobile terminal according to one embodiment of the present invention.

Referring to FIG. 1, a mobile terminal comprises a module connector 10 and a main body 100 for determining the type of a function module connected with the module connector 10 and controlling the function module.

The module connector 10 connects the main body 100 and the function module by combining with function modules performing particular functions such as a display module, a camera module, a laser pointer module, a remote control module, a memory module, an MP3 module and a Bluetooth module, etc., and relays the transmission of data between the main body 100 and the function module. Here, although only one module connector 10 is shown in FIG. 1, in another embodiment, a plurality of module connectors 10 may be used for combining with two or more function modules. For example, a user may use the camera function while listening to music by combining an MP3 module and a camera module with the main body 100 using two module connectors 10. Also, although the module connector 10 is shown to be formed on the upper part of the main body 100 in FIG. 1, it is apparent that it may be formed on any one of the four sides and the lower part of the main body 100.

The main body 100 determines the type of the function module combined through the module connector 10, and controls the operation of the function module. For example, in the case where the display module from among function modules is combined, the main body 100 supplies power to the display module, transmits data corresponding to the currently operational function (e.g. creating a message) to the display module, and controls the display module so that the data may be displayed. Therefore, the main body 100 requires software or hardware (hereinafter, referred to as control program to control each combinable function module. The control program is pre-stored in the memory of the main body 100 or in a particular storage medium combined with the main body 100.

Here, the mobile terminal can install the control program for the combined function module by downloading it from a particular server, in the case where the control program corresponding to the combined function module is not pre-stored. Therefore, when a new function module is combined (i.e. of which a corresponding control program is not pre-stored), the mobile terminal according to one embodiment of the present invention can install and execute the corresponding control program by downloading it in real-time from a particular server. Here, the particular server providing the control program, may be a single integrated server, or may be individual servers for the corresponding function modules. In one embodiment for the case of an integrated server, connection information of the server (e.g. URL) is pre-stored in the mobile terminal, and the mobile terminal connects to the server using the connection information to download the control program corresponding to the combined function module. In another embodiment for the case of downloading the control programs from individual servers, the mobile terminal downloads the control programs by connecting to the servers using the connection information received from the combined function modules.

In yet another embodiment, the function module may include the control program, so that the control program may be provided to the mobile terminal at the first occurrence combination. Therefore, when the combining function module is a new function module, the mobile terminal can receive the control program from the function module through the connector, to install and execute the program.

Therefore, the main body 100 of the mobile terminal according to one embodiment of the present invention may comprise a means of function module recognition for recognizing the type of the combined function module, a means of storage for storing the control program for each function module, a means of communication for communicating with a network to configure the corresponding control program when a new function module is combined, and a means of control for executing the control program corresponding to the combined function module.

Although FIG. 1 shows an antenna for communication formed on top portion of the main body 100, it may be formed inside the main body 100 for easier combination of the function modules through the module connector 10, or may also be rotatable or retractable so as to be inserted into the main body 100 with up/down movement. In other words, it is desirable that the antenna of the main body 100 be formed so as not to inhibit the combination of the function module with the main body 100.

Also, when a user makes a call or transmits a letter message, the main body 100 can comprise a displayer such as an LCD for displaying the inputted numerals or letters. That is, the mobile terminal may be equipped with a displayer for displaying basic image data such as inputted numerals or letters, etc., to provide user convenience of preventing errors in inputting numerals or letters, etc., when a user makes a call or transmits a letter message, without necessarily combining with the display module from among function modules.

Although the mobile terminal shown in FIG. 1 is assumed to be a cellular phone such as a PCS, it is apparent that other devices, such as PDA (personal digital assistants), may be implemented with certain characteristic elements (e.g. the module connector 10, etc.) of FIG. 1.

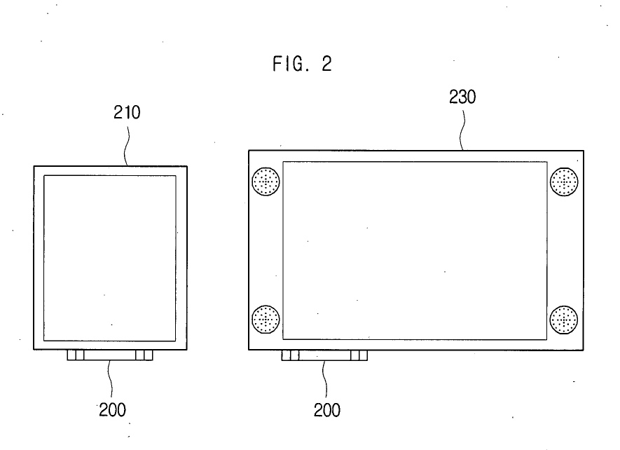

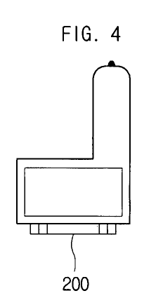

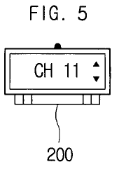

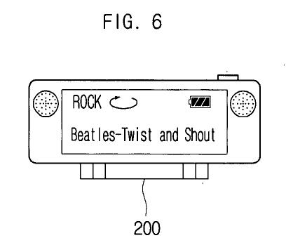

FIGS. 2 to 6 respectively show each function module according to embodiments of the present invention.

Referring to FIGS. 2 to 6, the function module comprises a connector 200 for combining with the module connector 10 of the mobile terminal. That is, each function module is combined with the mobile terminal using the connector 200, and data transmission is performed with the mobile terminal through the connector 200

FIG. 2 shows a display module, which may be applied as one of the function modules. Not only the LCD module 210 used in a typical mobile terminal, but also a wide LCD module 230 having a surround speaker module for games and broadcast viewing, as well as any other device that performs displaying functions can be applied as the display module.

Further, although the LCD module 210 and the wide LCD module 230, etc., were defined as examples of the display module, the LCD module 210 and the wide LCD module 230 may each be classified as a separate function module.

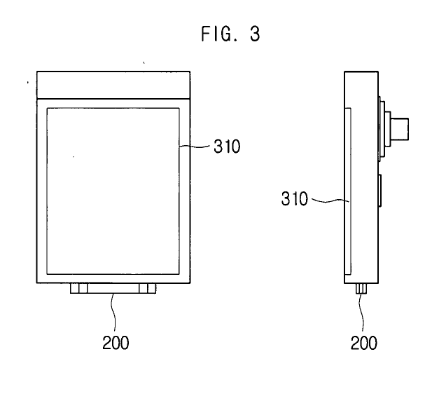

Similar to the display module having the connector 200 combinable with the module connector 10 of the mobile terminal, the camera module (it is desirable to have a displayer 310 such as an LCD for displaying a photographed image, as shown in FIG. 3), the laser pointer module, the remote control module and the MP3 module are shown in FIGS. 3 to 6, which may each be applied as one of a variety of function modules. It will become apparent from the following descriptions that other function modules, such as an external memory module and a Bluetooth module, that can perform particular functions by combining with the mobile terminal, currently developed or to be developed in the future, may also be applied.

As described above, the function module may store the connection information of a particular server, from which the mobile terminal can download the control program, to provide it to the mobile terminal at the first occurrence or at every occurrence of a combination, or may pre-store the control program to provide it at the time of the first combination.

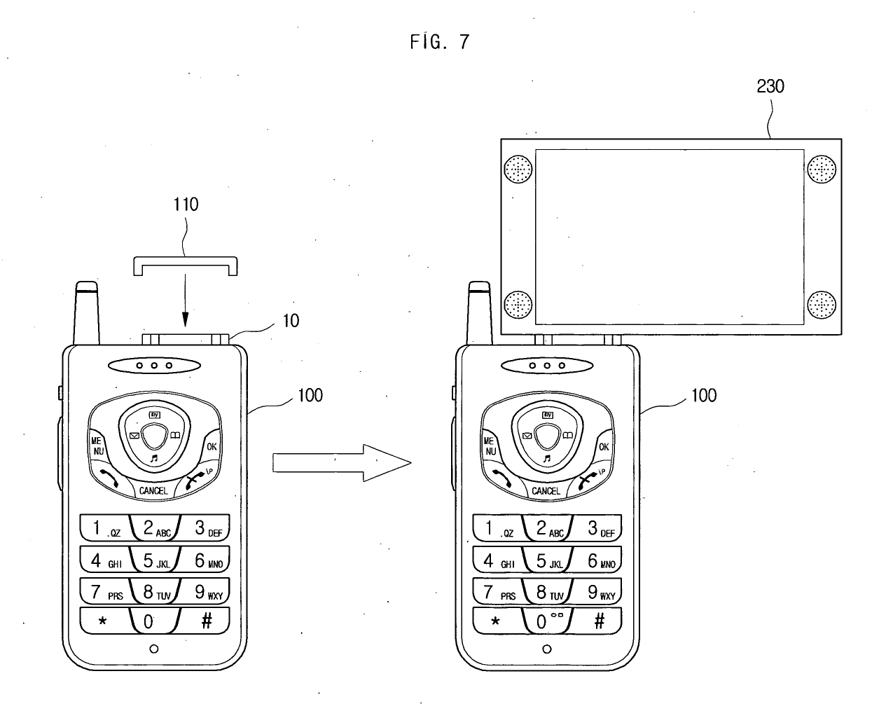

FIG. 7 shows a normal mobile terminal and the mobile terminal combined with a function module according to one embodiment of the present invention.

According to FIG. 7, a user of the mobile terminal can ordinarily use the mobile terminal with a cover 110 over the module connector 10. Thus, defective connections with the function modules due to the build-up of dust, etc., on the module connector 10 may be prevented. Obviously, in another embodiment, the user may ordinarily use the mobile terminal with a display module connected, such as an LCD module.

Therefore, since only basic functions of the mobile terminal such as voice conversations, are used by the user, the user may carry the mobile terminal without any function module combined, so as to reduce the weight of the mobile terminal.

As illustrated in FIG. 7, the wide LCD module having surround speakers may be combined with the mobile terminal, when the user wishes to play a game or watch broadcasts. Obviously, other function modules such as the camera module, the MP3 codec/surround module, the remote control module, and the Bluetooth module, etc., may also be combined with the mobile terminal.

Here, the mobile terminal can determine the type of the combined function module. Although various methods may be used, by which the mobile terminal (i.e. the main body 100) determines the type of the combined function module, only a few of such methods will be introduced in the following.

In one embodiment, when a function module is combined with the mobile terminal, the mobile terminal may supply power to the combined function module, and the mobile terminal may determine the type of the corresponding function module using a particular signal (i.e. a pre-specified signal for determining the type of the function module) received from the function module to which power has been supplied.

In another embodiment, the main body 100 of the mobile terminal may transmit to the function module a pre-configured signal for determining the type of the function module after supplying power, and the function module may transmit the above-mentioned particular signal to the main body 100 of the mobile terminal. In yet another embodiment, the main body 100 of the mobile terminal may determine the type of the function module by measuring a distinctive resistance value of the function module combined through the module connector 10.

Here, in the case where the mobile terminal cannot determine the type of the function module using the signal transmitted from the combined function module, the combined function module can be recognized as a new function module by the mobile terminal. Of course, the function module may provide to the mobile terminal a signal indicating that it is a new module.

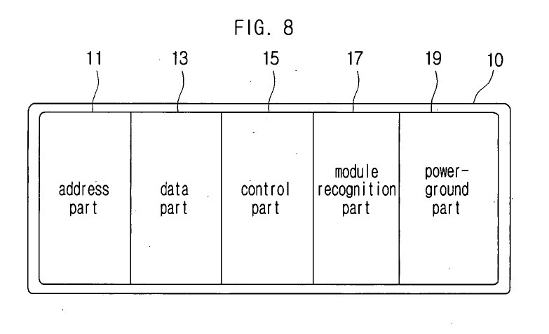

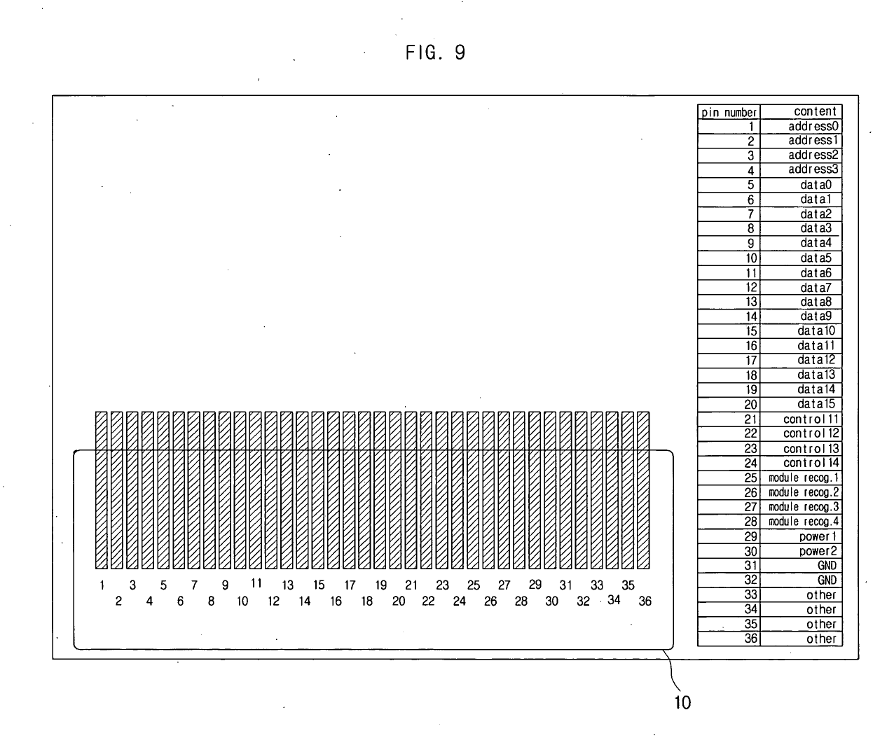

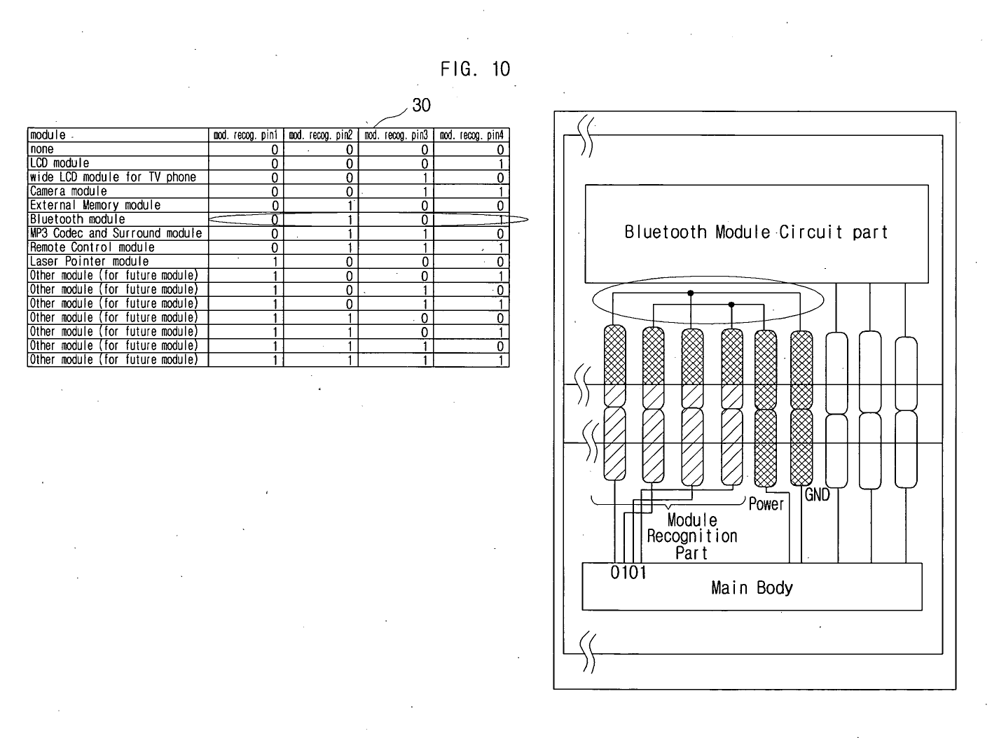

FIG. 8 shows the composition of a module connector according to one embodiment of the present invention, FIG. 9 shows a pin map of a module connector according to one embodiment of the present invention, and FIG. 10 shows a function module recognition table for function module type recognition and an example of such recognition according to one embodiment of the present invention.

Referring to FIG. 8, the module connector 10 comprises an address part 11, a data part 13, a control part 15, a module recognition part 17 and a power-ground part 19. Each component has at least one line, which can be formed by pins, etc.

The main body 100 of the mobile terminal determines the type of the function module using the signal received from the function module through the module recognition part 17 of the module connector 10. That is, the main body 100 supplies power to the function module through the power-ground part 19 and determines the type of the corresponding function module by the signal received from the function module. The power-ground part 19 is a line for supplying power by the main body 100 to the function module or for grounding when a function module is combined.

Referring to FIG. 9, a total of sixteen (=24) function modules can be distinguished by the 4 allotted pins (see pin no. 25 to 28) in the module recognition part 17. That is, circuits are designed in the body of the function module or the connector 200 to enable the function module to transmit a pre-configured particular signal when it is combined, so that the main body 100 can recognize the type of the function module. Thus, the main body 100 of the mobile terminal can determine the type of the combined function module using a function module recognition table 30, such as that shown in FIG. 9, which includes a configuration of pre-stored information regarding the particular signal transmitted from each function module (hereinafter referred to as module-recognition information. Here, the connector 200 of the function module has a module-recognition information transmitting part (not shown) for transmitting the module-recognition information to the module recognition part 17 of the module connector 10. For example, if the module recognition part 17 of the module connector 10 is formed of 4 pins, the module-recognition information transmitting part can be 4 terminals combining with the module recognition part 17. Thus, the function module transmits the pre-configured module-recognition information through the module connector 10 of the mobile terminal by the module-recognition information transmitting part of the connector 200.

Referring to FIG. 10, when a Bluetooth module is combined with the main body 100 through the module connector 10, the Bluetooth module transmits a signal corresponding to the module-recognition information “0101” to the main body 100 of the mobile terminal, as described in the function module recognition table 30, via the 4 lines (or 4 pins) of the module recognition part 17. Therefore, the main body 100 can recognize the function module combined by the module connector 10 to be a Bluetooth module, using the module-recognition information received from the function module.

Here, as described in FIG. 10, some extra values are allotted in the function module recognition table 30 for those function modules that have not yet been configured. Thus, the mobile terminal can download from particular servers, etc., the control program corresponding to that function module which has transmitted a value not yet configured as the module-recognition information. For example, if the mobile terminal receives the module-recognition information having a value of “1010” from the combined function module, the function module is recognized to be a new function module, and the control program for controlling the corresponding function module is downloaded and installed for execution.

Referring again to FIG. 8, the address part 11 comprises lines (or pins) for transmitting address information on the area where the data transmitted/received between the function module and the main body 100 is stored, and the data part 13 comprises lines for transmitting/receiving the data corresponding with the function of the function module between the function module and the main body 100, and the control part 15 comprises lines for transmitting/receiving a control signal and/or a response signal necessary for operation of the function module. Therefore, the main body 100 of the mobile terminal can control the data transmission to/from the combined function module and control the operation of the function module using the address part 11, the data part 13, and the control part 15 of the module connector 10.

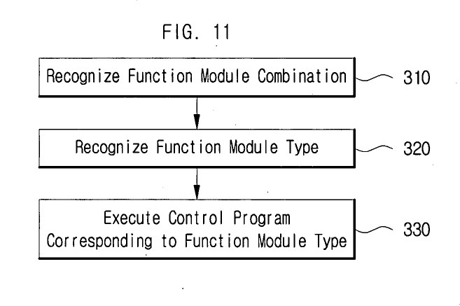

FIG. 11 is a flowchart illustrating the operation of the mobile terminal for controlling a combined function module according to one embodiment of the present invention.

Referring to FIG. 11, in step 310 the main body 100 recognizes that function module is combined. When the function module is combined with the module connector 10, the main body 100 can recognize this by generating an interrupt signal using switching or Plug-and-Play functions, etc.

In step 320, the main body 100 recognizes the type of the function module by analyzing the particular signal received from the combined function module. As described above, the main body 100 recognizes the type of the function module using the pre-stored function module recognition table 30 and the signal received through the module recognition part 17 of the module connector 10. Here, the main body 100 may supply power to the function module through the power-ground part 19 of the module connector 10, to recognize by the signal received the function module that the function module is combined and determine the type of the corresponding function module.

Further, when the combined function module has transmitted a signal not yet configured in the stored function module recognition table 30, the mobile terminal may preferably recognize it as a new one, and obtain the control program of the corresponding function module from a particular server through a network using information (e.g. the module-recognition information) about the new function module. Of course, the module-recognition information of the new function module can be configured in the function module recognition table 30.

In step 330, the main body 100 extracts and executes the control program corresponding to the recognized type of the function module from a storing module (not shown).

Hereinafter, the process will be described by which the mobile terminal configures the control program corresponding to the new function module, for the case where a new function module is combined that does not have a pre-configured control program.

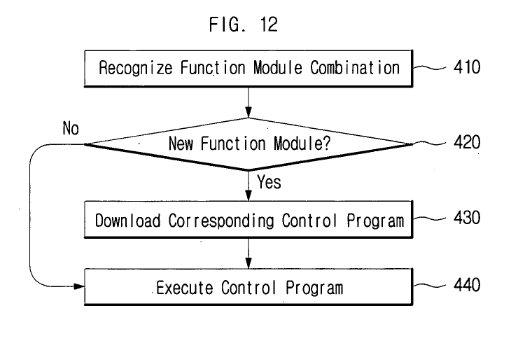

FIG. 12 is a flowchart illustrating the operation of the mobile terminal for configuring the control program of a newly combined function module.

In step 410, the mobile terminal recognizes that a function module is combined, and receives the module-recognition information from the combined function module.

In step 420, the mobile terminal determines whether or not the combined function module is a new one by the received module-recognition information. In the case that the information on the type of the function module according to the received module-recognition information is not configured, the function module may be recognized as a new one.

If the result of the determination indicates that it is not a new function module, i.e. that the control program for the corresponding function module is configured, the mobile terminal executes the control program corresponding to the combined function module in step 430.

If the result of the determination indicates that it is a new function module, the mobile terminal configures the control program corresponding to the combined function module. The configuration for the control program may be obtained by downloading from a particular server pre-configured to provide an integrated control program through a network, by downloading from the server device corresponding to the connection information (e.g. wireless internet URL, WINC (wireless internet numbers for contents), etc.) received from the corresponding function module, or if it is pre-stored in the combined function module, by receiving it directly from the function module. In addition, when the mobile terminal downloads an integrated control program from the servers described above to selectively configure the control program corresponding to the combined function module, it may first search for the corresponding control program from the integrated control program. The following descriptions, however, will be based on the assumption that only one server (hereinafter referred to as control program providing server) provides the control program.

If the result of the determination in step 420 indicates that the combined function module is a new function module (i.e. the control program is not yet configured), the mobile terminal connects to the control program providing server through a network (e.g. CDMA network, WCDMA network, etc.) using the pre-stored connection information, and downloads the control program corresponding to the function module. Here, the mobile terminal transmits function module-recognition information to the control program providing server so that the control program providing server may recognize the corresponding function module and provide the control program corresponding to it. The function module-recognition information may include one or more of the module-recognition information received from the function module, an identification code for identifying each function module, and function module information (e.g. at least one of a name, manufacturer, and product code, etc.) etc. Therefore, the control program providing server may search the corresponding control program using the function module-recognition information received from the mobile terminal, and may provide the searched control program to the mobile terminal. Here, the mobile terminal may pre-store the function module-recognition information such as the identification code and the function module information etc. in correspondence with the module-recognition information, or may receive the identification code and the function module information, etc., from the combined function module.

Of course, it is apparent that the mobile terminal may display via the displayer the list of control programs searched by the control program providing server connected through a network, and then download and install the control program selected by the operation of a user via an input part. It is also apparent that the mobile terminal may provide a user interface for this.

In step 440, the mobile terminal executes the control program installed after downloading. The combined function module is controlled by the mobile terminal in step 440, and the user may utilize the combined function module using the mobile terminal.

Here, even though the control program according to the combined function module may be pre-configured, the mobile terminal may determine whether or not the version of the corresponding control program is the latest version, and if it is not the newest, may upgrade the stored control program to the latest version by connecting to the control program providing server. For example, by connecting to the control program providing server and providing the function module-recognition information of the combined function module, the mobile terminal may receive information on the latest version of the control program according to the corresponding function module for comparison with the currently configured control program.

At least one embodiment of the present invention can provide a mobile terminal which allows a function module to be selectively combined and detached with a function module for each function such as camera and MP3 player functions, etc., and a method for controlling the function module.

At least one embodiment of the present invention can provide a mobile terminal and a method for determining the type of combined function module, and executing a control program in correspondence with the determination result.

At least one embodiment of the present invention can provide a mobile terminal combinable with various types of function module with which a control program corresponding to a new function module may be downloaded from a particular server for automatic configuration.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A mobile terminal connectable to various types of function module, the mobile terminal comprising:
at least one module connector; and
a main body configured to i) determine the type of at least one function module connected to the at least one module connector and to ii) control the connected function module.

2. The mobile terminal of claim 1, wherein the function module comprises at least one of the following: a display module, a camera module, a laser pointer module, a remote control module, an external memory module, an MP3 module and a Bluetooth module.

3. The mobile terminal of claim 1, wherein the module connector comprises a module recognition section, wherein the main body is further configured to recognize the type of the connected function module based on module-recognition information received via the module recognition section.

4. The mobile terminal of claim 3, wherein the module connector further comprises an address section, a data section, a control section, and a power-ground section.

5. A function module comprising:
a main body; and
a connector, comprising a module-recognition information transmitter, wherein the connector is configured to be connected to a module connector of a mobile terminal, and wherein the module-recognition information transmitter is configured to provide mobile terminal module-recognition information corresponding to the main body to the mobile terminal.

6. A mobile terminal connectable to various types of function module, the mobile terminal comprising:
at least one module connector;
a main body configured to i) determine the type of at least one function module connected to the module connector and to ii) control the connected function module; and
a memory configured to store a plurality of control programs corresponding to each function module,
wherein the main body is further configured to receive a corresponding control program from a predetermined server via a network or from the connected function module via the module connector, if the control program for the function module is not stored in the memory.

7. The mobile terminal of claim 6, wherein connection information for connecting to the server is pre-stored in the memory or is received from the connected function module.

8. The mobile terminal of claim 6, wherein the main body is further configured to i) determine whether or not the version of the control program corresponding to the function module is the latest version when the control program for the function module is pre-stored in the memory or received from the function module, and to ii) update the control program with the latest version via the server.

9. The mobile terminal of claim 6, wherein the main body is further configured to transmit function module-recognition information by which the server can recognize the function module.

10. The mobile terminal of claim 6, wherein the module connector comprises a module recognition section, wherein the main body is further configured to recognize the type of the function module based on module-recognition information received via the module recognition section.

11. A method of controlling a function module connected to a mobile terminal, the method comprising:
receiving module-recognition information from the function module connected to a module connector of the mobile terminal;
determining whether or not a control program corresponding to the module-recognition information is stored in the memory;
if the control program is not stored, receiving the control program from a predetermined server via a network or from the connected function module; and
executing the received control program.

12. The method of claim 11, wherein connection information for connecting with the server is pre-stored or is received form the function module.

13. The method of claim 11, further comprising:
determining whether or not the version of the control program corresponding to the function module is the latest version when the control program for the function module is pre-stored or is received from the function module;
updating the control program with the latest version via the server; and
executing the updated control program.

14. A mobile terminal-readable recording medium storing a program to cause a mobile terminal to execute a method of controlling a combined function module, the method comprising:
receiving module-recognition information from the function module connected to a module connector of the mobile terminal;
determining whether or not a control program corresponding to the module-recognition information is stored in the memory;
if the control program is not stored, receiving the control program from a predetermined server via a network or from the connected function module; and
executing the received control program.

15. The mobile terminal-readable recording medium of claim 14, wherein connection information for connecting to the server is pre-stored or is received form the function module.

16. The mobile terminal-readable recording medium of claim 16, further comprising:
determining whether or not the version of the control program corresponding to the function module is the latest version when the control program for the function module is pre-stored or is received from the function module;
updating the control program with the latest version via the server in correspondence with the result; and
executing the updated control program.

17. A mobile terminal connectable to various types of function module, the mobile terminal comprising:
means for receiving module-recognition information from the function module connected to a module connector of the mobile terminal;
means for determining whether or not a control program corresponding to the module-recognition information is stored in the memory;
means for if the control program is not stored, receiving the control program from a predetermined server via a network or from the connected function module; and
means for executing the received control program.
